(19) United States
(12) Patent Application Publication
(10) Pub. No.: US 2025/0338796 A1
(43) Pub. Date: Nov. 6, 2025

(54) FRUIT HARVESTER

(71) Applicant: Kuwait University, Safat (KW)

(72) Inventors: Abdullah F. ALAJMI, Sabah Al Nasser Area (KW); Anwar Saleh ALENEZI, Surra (KW); Sara Mansour Ali ALKHALDI, Fintas (KW); Khadeejah Ali ALSHEMERI, Saad Al Abdullah (KW); Shahad Khaled Rashed ALHAJRI, Sulibikhat (KW)

(21) Appl. No.: 18/653,076

(22) Filed: May 2, 2024

(51) Int. Cl. A01D 46/24; A01D 46/253

(52) U.S. Cl. CPC A01D 46/243; A01D 46/253; A01D 46/30

(57) ABSTRACT

A fruit harvester including an extendable frame having mated, parallel-extending frame members. A winch and wire are provided in connection with the parallel-extending frame members causing the frame to be extended upon winding the wire, and compact upon unwinding the wire. The fruit harvester includes a cutting tool mounted to the frame and a collection basket mounted underneath the cutting tool. The cutting tool is movable on linear rails along a first axis in a forward and backward direction, a second axis in a side-to-side direction, as well as rotationally in a clockwise or counter-clockwise direction. A combination of controllers and motors are used to control motion of the cutting tool.

### BACKGROUND

### Field

The disclosure of the present patent application relates to fruit harvesting machines, and particularly to a fruit harvester for date palm fruits.

### Description of Related Art

The date palm has been a major fruit crop for generations in the Middle East and North Africa. Arab countries in the Middle East and North Africa possess 70% of the total available palm trees in the world and 65% of the date palm production, with the production of dates reaching 9 million tonnes in the Middle East alone. Palm trees can live over 100 years, and withstand hot temperature, saline soil, and dry climate, which have made the date palm a symbol for life in the desert. The date palm, or Phoenix dactylifera L., is a type of a flowering plant species within the palm family, having spherical/cylindrical shaped dates. The trunk of the date palm tree is graceful, shining, and pinnate, and can reach heights of 5 meters.

The date harvesting process has been a difficult job for centuries due to the height of the tree and the need for climbing the tree. Today, there are two general categories of harvesting dates: traditional manual methods and modern mechanical methods. In a traditional manual method, a skilled worker climbs the palm tree with or without a belt tied around their waist and the trunk of the tree. The fruit bunch is cut using sharp tools and placed in a sac or tied with rope and lowered to the ground. The traditional manual method is disadvantageous for a variety of reasons, primarily safety of the worker and efficiency of the process.

Known mechanical methods of harvesting dates include the use of large hydraulic lifts to elevate a worker to the height of the date palm fruit to collect the dates. Although this method saves time and effort by comparison with traditional manual methods, it is disadvantageous when harvesting is done in a small farm where the large hydraulic lift cannot move between closely spaced trees. Furthermore, such mechanical systems are expensive and infeasible in many poor areas.

Thus, a fruit harvester is desired providing a safe alternative to traditional manual methods while being more compact and inexpensive than typical large harvesting machines.

### SUMMARY OF THE INVENTION

The fruit harvester disclosed herein includes an extendable frame, the extendable frame including mated, parallel-extending frame members. A winch is included, the winch having a wire mounted on pulleys in connection with the parallel-extending frame members. Upon applying tension to (i.e. winding) the wire, the parallel-extending frame members move into an extended, elevated position. Upon releasing tension (i.e. unwinding) the wire, the frame members move into a compact, un-extended position.

The fruit harvester includes a cutting tool mounted on an uppermost frame member of the extendable frame. A collection basket is included and mounted underneath the cutting tool for the collection of fruit.

According to an embodiment, a first linear guide rail is mounted in connection with the cutting tool. The first linear guide rail is configured to move the cutting tool along a first axis, such as in a forwards and backwards direction. A second linear guide rail is included, the second linear guide rail mounted in connection with the cutting tool and configured to move the cutting tool along a second axis, such as in a side-to-side direction. In addition, the cutting tool is mounted for rotational movement in a clockwise or counter-clockwise direction.

According to an embodiment, the parallel-extending frame members are mated through rollers positioned within guide slots.

According to an embodiment, the fruit harvester includes a base frame, wherein the extendable frame is mounted to the base frame and supported by one or more support struts mounted to the base frame and the extendable frame. The base frame may include wheels for the fruit harvester and one or more handrails sized and positioned to be gripped for moving the fruit harvester to a desired location.

According to an embodiment, the fruit harvester includes a power source and a controller. The controller may be used to operate the winch and/or the cutting tool, the cutting tool mounted for rotational movement, as well as movement along a first axis and a second axis. The fruit harvester may include one or more housings for storage of the power source and other electronic components.

These and other features of the present subject matter will become readily apparent upon further review of the following specification.

### BRIEF DESCRIPTION OF DRAWINGS

FIG. 1 is a front perspective view of a fruit harvester.

FIG. 2A is a side view of a fruit harvester in an extended, elevated position.

FIG. 2B is a perspective view of a fruit harvester in a compact, un-extended position.

FIG. 2C is a rear perspective view of a fruit harvester.

FIG. 2D is a front view of a controller used in a fruit harvester.

FIG. 3A is a rear perspective view of a frame of a fruit harvester in an extended, elevated position.

FIG. 3B is a front perspective view of frame members of a fruit harvester in exploded configuration.

FIG. 3C is a perspective view of a middle frame member in exploded configuration.

FIG. 3D is a perspective view of a top frame member in exploded configuration.

FIG. 4A is a perspective view of a linear guide rail.

FIG. 4B is a perspective view of first and second linear guide rails in exploded configuration.

FIG. 5 is a perspective view of a cutting tool mounted for rotational movement on first and second linear guide rails.

Similar reference characters denote corresponding features consistently throughout the attached drawings.

### DETAILED DESCRIPTION

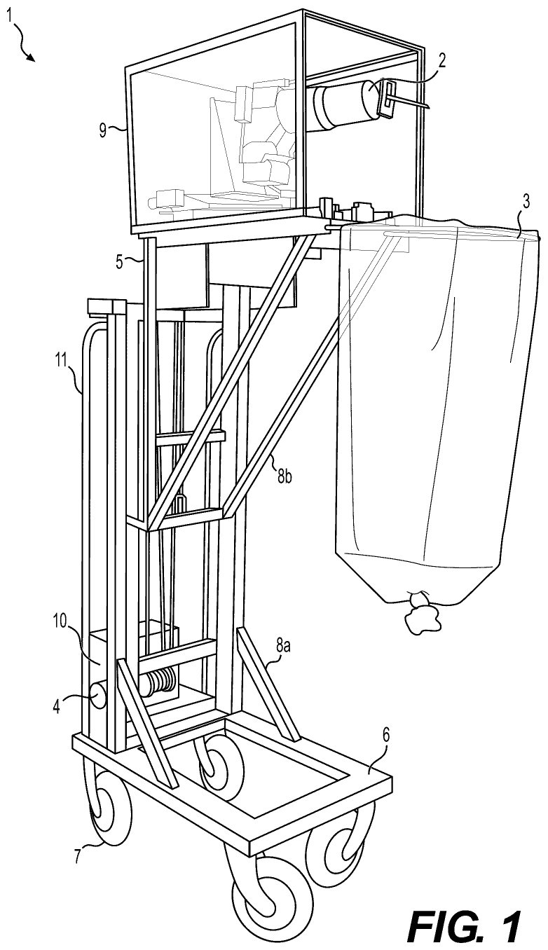

FIG. 1 is a perspective view of a fruit harvester 1. The fruit harvester 1 includes a cutting tool 2, such as a saw, mounted on an uppermost frame member of extendable frame 5 and within a protective enclosure 9. A collection basket 3 is positioned beneath cutting tool 2 for collection of fruit. In a non-limiting embodiment, the fruit is date palm fruit. A winch 4 is shown mounted to a base frame 6 for extending the one or more frame members of extendable frame 5. Support struts 8a are included for support of the extendable frame 5 in connection with base frame 6. Wheels 7 as well as handrails 11 are included. Handrails 11 are sized and positioned to be gripped by a user to transport the fruit harvester 1 to a desired location. An advantageous feature of the fruit harvester 1 is that the overall size and weight are such that an average-sized worker is able to push the fruit harvester 1 into a desired position for the collection of fruit. The fruiter harvester 1 is smaller than typical large hydraulic machines used to harvest fruit and is able to be transported between closely spaced date palm trees, unlike large hydraulic lift machines.

A housing 10 is included for storage of components such as a power source and controller (not shown). The power source may be, for example, a 12V battery. The controller may include any necessary electronic hardware and software components for control of the winch and/or cutting tool. These include printed circuit boards, processors, computer readable memory, electrical wiring, resistors, transistors and other electronic components known in the art. An example controller used in the prototyping of the fruit harvester 1 was the Arduino Uno microcontroller programmed to control the cutting tool (described below) in connection with other electronic components (circuit board, power supply, resistors, etc.).

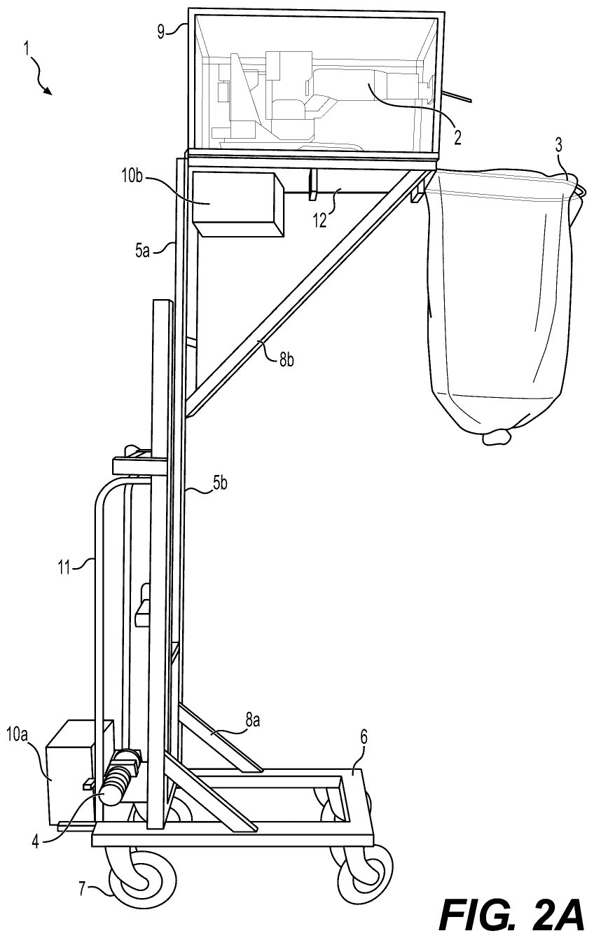

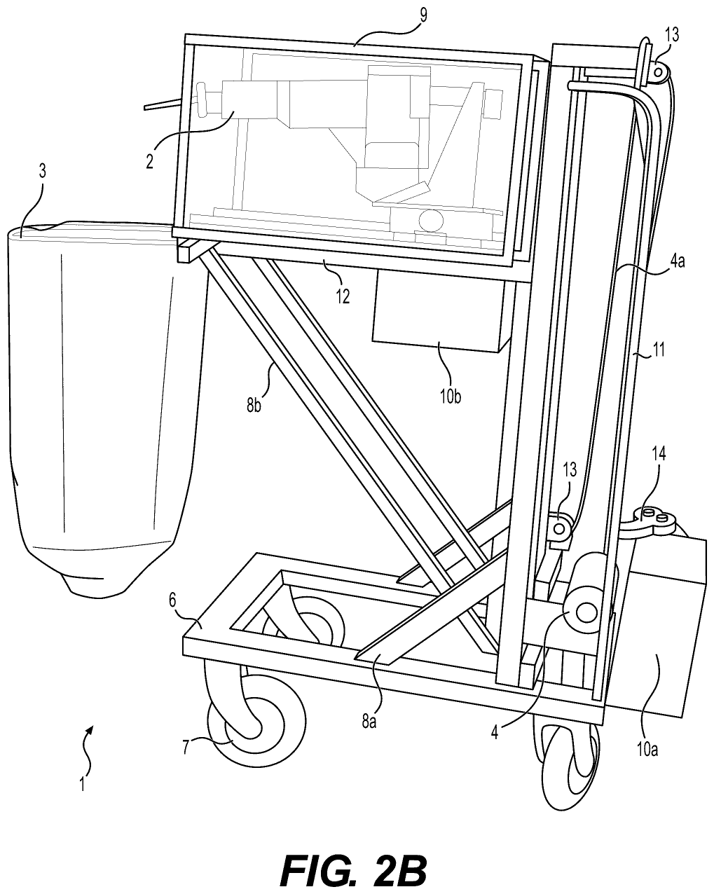

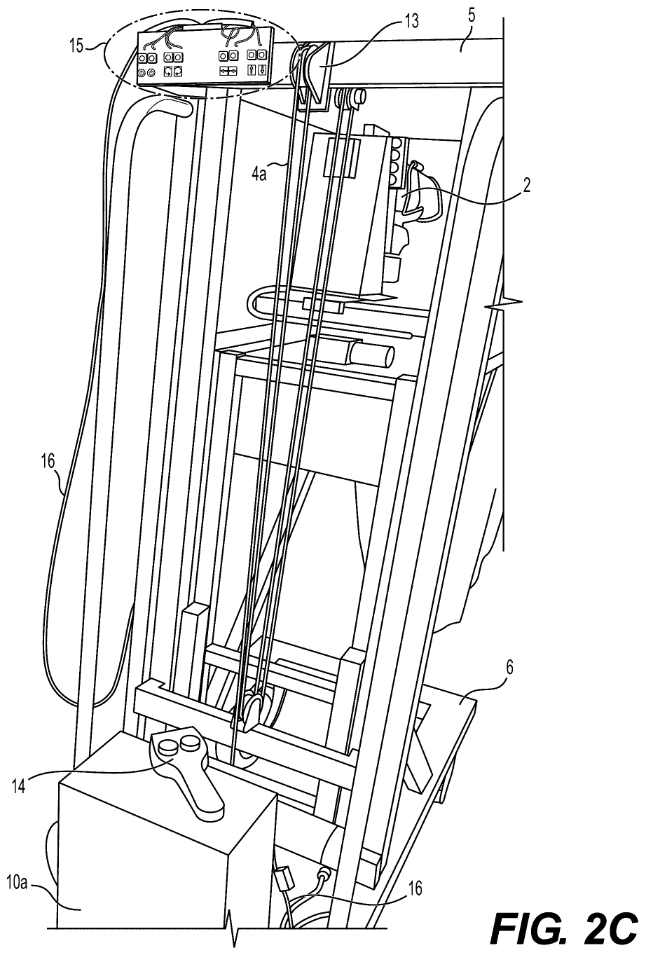

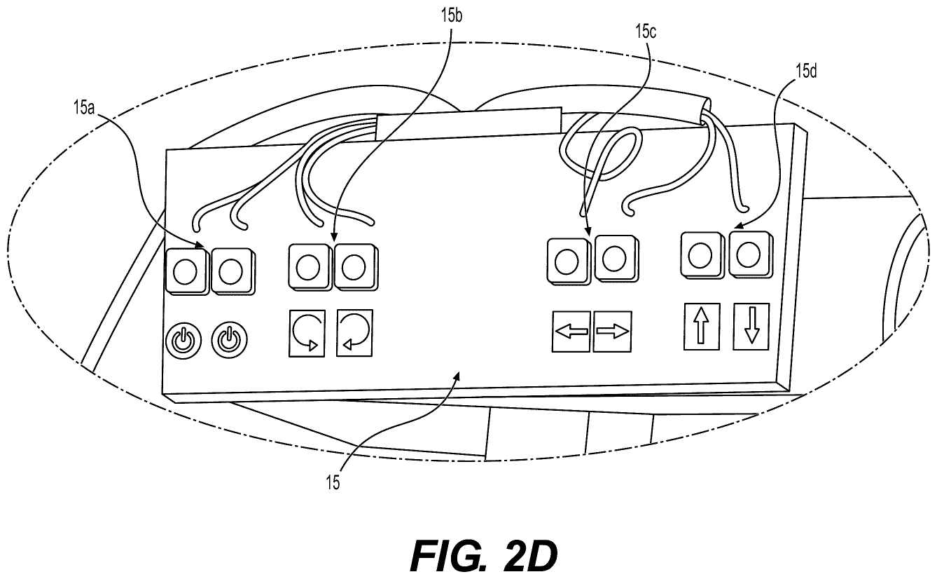

Referring to FIG. 2A, the fruit harvester may include first and second electronic housings 10a, 10b for storage of necessary power and control components used for control of the winch 4 and cutting tool 2, respectively. Although two housings are shown, a single housing, or multiple housings may be used to store all the necessary electronics for control of the winch and cutting tool.

A first frame member 5a and second frame member 5b are shown in FIG. 2A, the frame members being in an extended position through winding and applying tension to a wire of the winch 4. Support struts 8a and 8b are shown for support of the upper and lower portions of the extendable frame, respectively.

FIG. 2B shows the fruit harvester in a compact, un-extended position achieved through unwinding of the winch wire 4a connected to the extendable frame through pulleys 13. FIG. 2C is a rear perspective view again showing wire 4a connected to the extendable frame 5 through pulleys 13. Electrical wiring 16 is shown and a controller 14 is used for operating the winch 4. A controller 15 is shown for operating the cutting tool 2. Although two controllers are shown, a single controller is also envisioned for combined operation of the winch and cutting tool.

FIG. 2D is a closer view of controller 15 for operation of the cutting tool. Controller 15 includes buttons such as 15a for powering on/off the cutting tool, 15b for rotational movement, 15c for side-to-side movement as well as 15d for forwards and backwards movement. Other buttons as needed are also contemplated for use with controller 15.

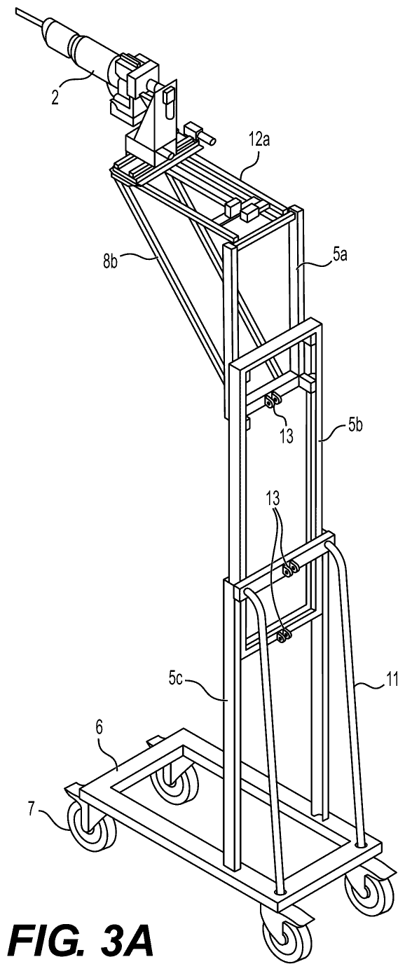

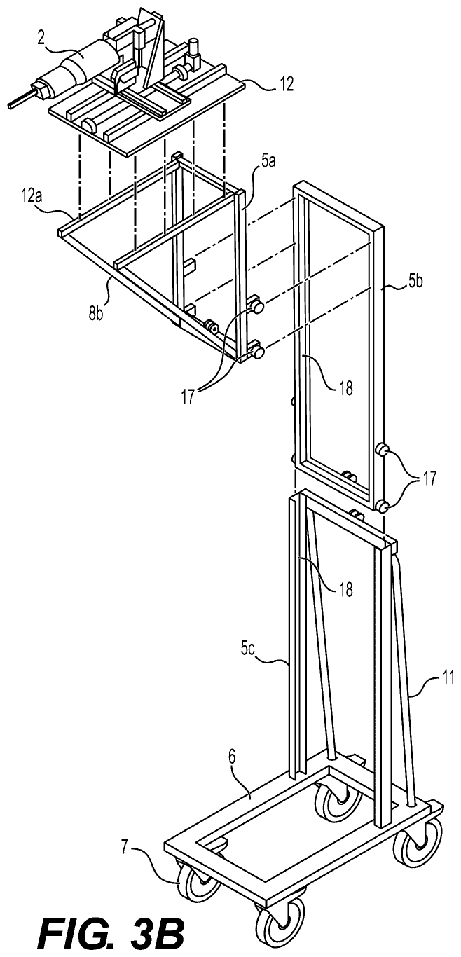

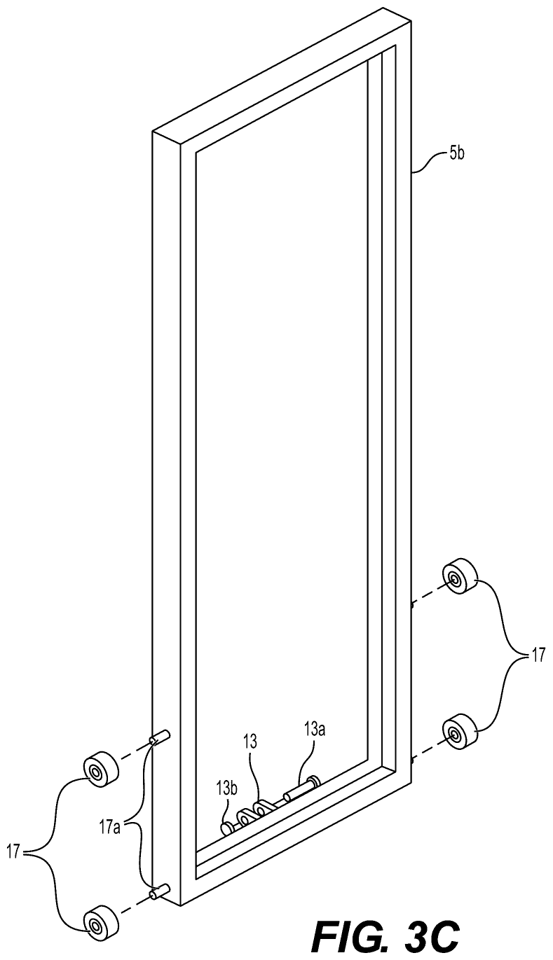

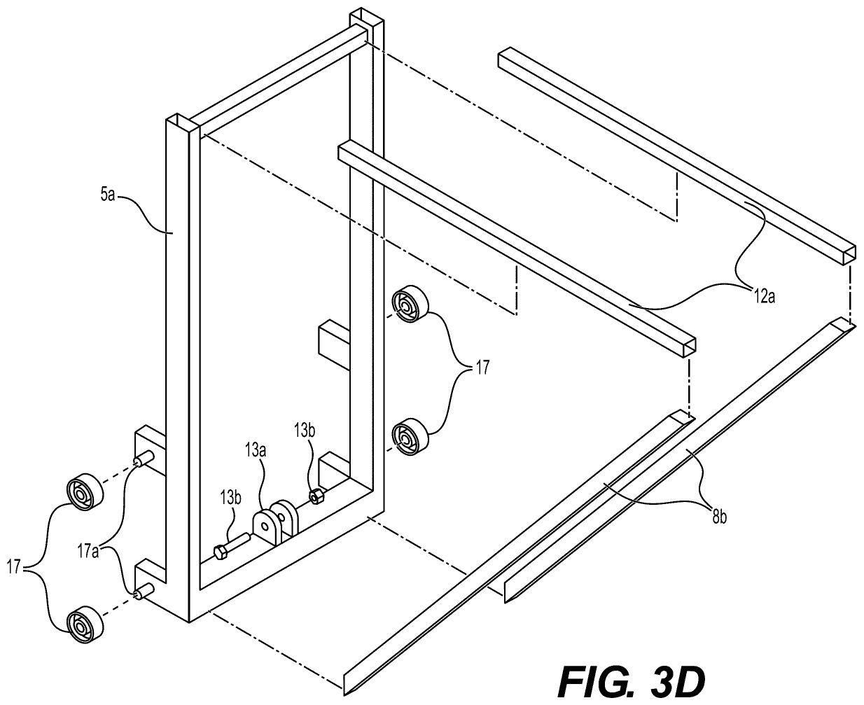

FIG. 3A provides a view of the frame members 5a-c of the fruit harvester 1 in an extended position. Three frame members are shown, an upper frame member 5a, middle frame member 5b and lower frame member 5c. One or more fasteners and/or pulleys 13 are provided for attachment of the winch wire to the extendable frame. While three frame members are shown, this is for illustrative purposes and more or less frame members may be employed.

FIG. 3B shows a roller and slot mating arrangement of the extendable frame allowing for parallel extension of the frame members. Rollers 17 are provided on the outer surface of upper frame member 5a and middle frame member 5b. Guide slots 18 are formed on an inner surface of middle frame member 5b and lower frame member 5c for reception of the rollers 17. FIG. 3C shows middle frame member 5b fitted with rollers 17 mounted on roller shafts 17a on an outer surface. Pulley 13 is fitted with bolt 13a and nut 13b for receiving the winch wire. Likewise, FIG. 3D shows a similar arrangement on upper frame member 5a fitted with rollers 17 on shafts 17a. Supports 12a are included for mounting of the cutting tool platform through support and connection by struts 8b.

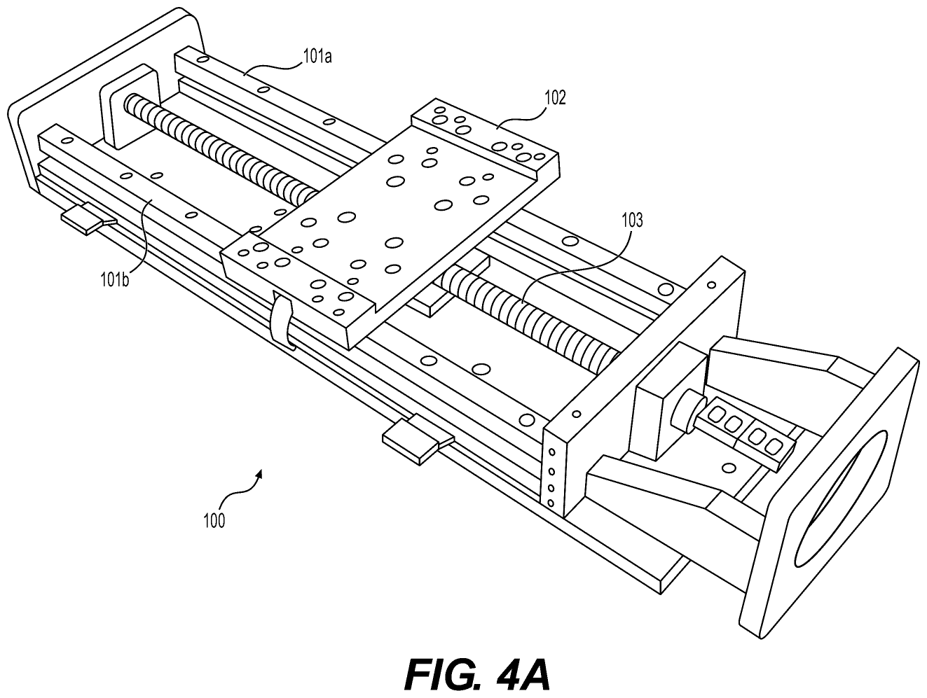

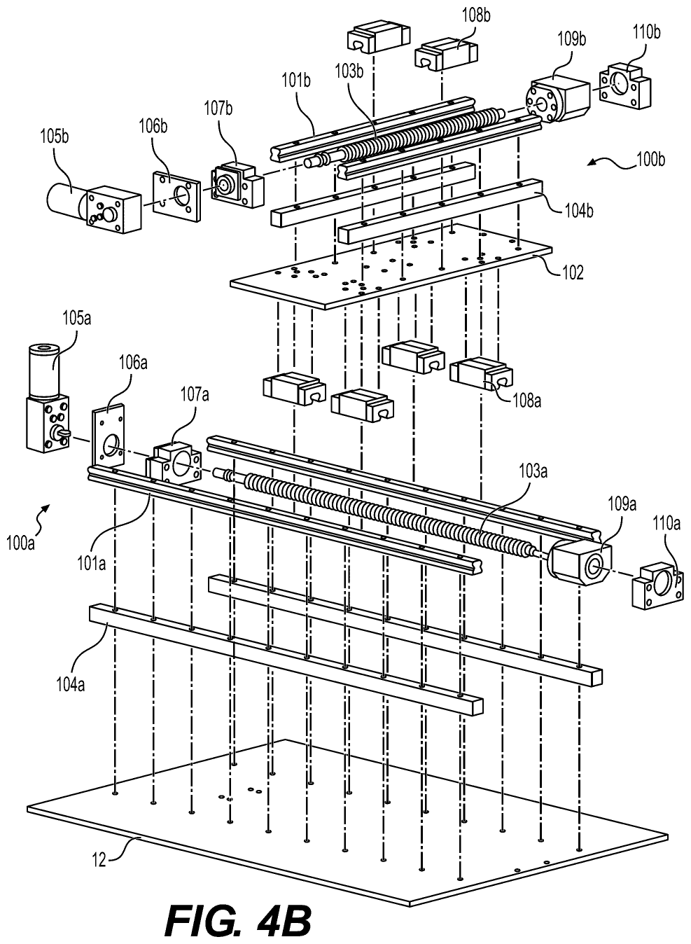

FIG. 4A is an example of a linear rail 100 of the type that may be used with the fruit harvester for movement of the cutting tool. The linear rail 100 includes railings 101a, 101b, a movable platform 102 and a ball screw 103. FIG. 4B shows additional components used for movement of the cutting tool, including first linear rail 100a and second linear rail 100b. In addition to ball screws 103a, 103b, rail extensions 104a, 104b are included as well as DC motors 105a, 105b and motor mount plates 106a, 106b. Motor end support units 107a, 107b serve to couple the DC motors 105a, 105b to ball screws 103a, 103b respectively.

To facilitate the movement of the cutting tool, ball screw nuts 109a, 109b are mounted on ball screws 103. Ball screw nuts 109a, 109b are provided with a flat upper surface and mounting holes (not shown) for coupling to a platform surface, such as platform 102. In operation, DC motors 105a, 105b rotate ball screws 103a, 103b causing respective ball screw nuts 109a, 109b and thus the mounted platform, to move along their respective axis. End support units 110a, 110b are coupled to the end of ball screws 103 opposite from respective DC motors 105a, 105b. Rail sliders 108a, 108b are provided for coupling and movement along rails 101a, 101b.

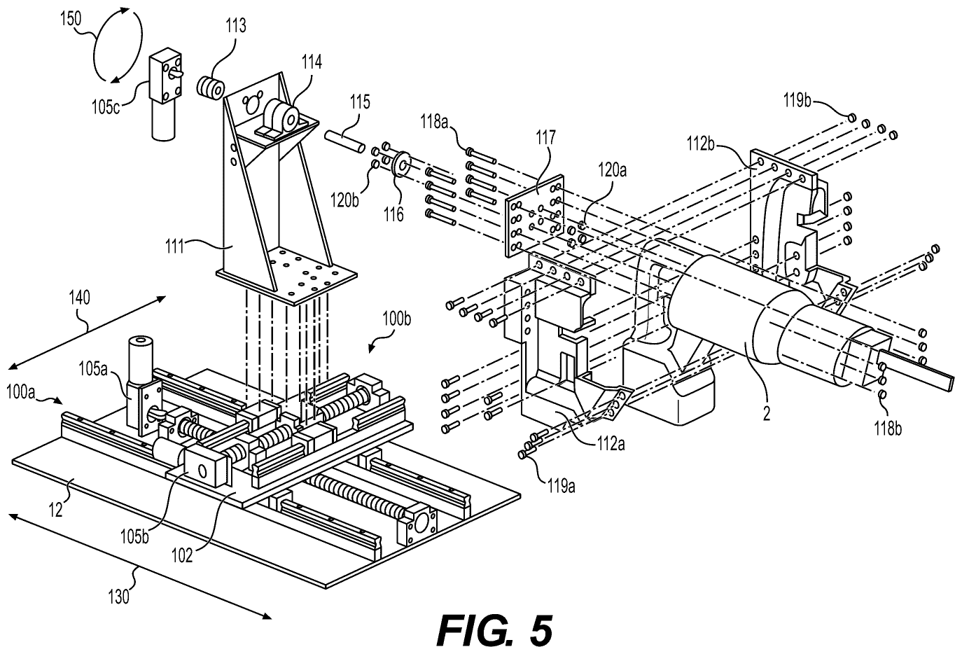

FIG. 5 shows an example mounting arrangement of cutting tool 2 on linear rails 100a, 100b. A first mount 111 is provided for the cutting tool. First mount 111 is fastened to the ball screw nut of linear rail 100b. A second mount made up of halves 112a, 112b is also provided for the cutting tool 2. Halves 112a, 112b are joined together through nuts 119a, bolts 119b. First mount 111 and second mount 112 are joined through the mounting arrangement shown which includes DC motor 105c, motor coupler 113, bearings 114, shaft 115 and mount plate 117. Bolts 118a, 120a, and respective nuts 118b, 120b are provided to join mount plate 117 to second mount 112. A flange coupling 116 is also shown.

DC motor 105c and shaft 115 are joined to cutting tool 2 to provide rotary motion 150 of cutting tool 2. To rotate cutting tool 2, controller 15 of FIGS. 2C-D sends a signal to DC motor 105c to rotate in a clockwise or counter-clockwise direction, as indicated by buttons 15b of FIG. 2D and arrows 150 of FIG. 5.

First mount 111, as shown, is a custom steel mounting structure, while second mount 112 and mount plate 117 are custom 3D printed structures made specifically for the cutting tool 2 shown. However, the mounting structures shown are examples only and other shapes and materials may be used to accomplish the features described herein.

In addition to rotary motion 150 through DC motor 105c, cutting tool 2 moves along first axis 130 through rotation of DC motor 105a and second axis 140 through rotation of DC motor 105b. Linear motion is provided as a results of the rotation of respective ball screws and translated movement of the mounted ball screw nuts provided on linear rails 100a, 100b, as previously described with references to FIG. 4B. In the mounting arrangement of FIG. 5, cutting tool 2 is thus able to move along first axis 130 in a forwards and backwards direction, second axis 140 in a side-to-side motion and rotationally 150 in a clockwise or counter-clockwise direction. Thus, the cutting tool 2 is able to be precisely moved and positioned during operation.

It is to be understood that the fruit harvester as shown is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A fruit harvester, comprising:
an extendable frame, wherein the extendable frame includes mated, parallel-extending frame members;
a winch, wherein the winch is configured to wind or unwind a wire mounted on the parallel-extending frame members, whereby the frame members are configured to move into an extended position upon the wire being wound, and the frame members are configured to move into a compact position upon the wire being unwound;
a cutting tool mounted on an uppermost frame member of the extendable frame;
a collection basket mounted underneath the cutting tool;
a first linear rail mounted to the uppermost frame member of the extendable frame;
a second linear rail mounted to the first linear rail;
a first mount connecting the second linear rail with the cutting tool;
a motor mounted to the first mount; and
a shaft extending between the motor and the cutting tool, wherein the shaft connects the motor with the cutting tool,
wherein the first linear rail is configured to move the second linear rail, the first mount and the cutting tool along a first axis,
wherein the second linear rail is configured to move the first mount and the cutting tool along a second axis, different from the first axis, and
wherein the motor is configured to rotate the shaft, and the shaft is configured to rotate the cutting tool.

2-4. (canceled)

5. The fruit harvester as recited in claim 1, wherein the parallel-extending frame members are mated through rollers positioned within guide slots.

6. The fruit harvester as recited in claim 1, further comprising:
a base frame, wherein the extendable frame is mounted to the base frame.

7. The fruit harvester as recited in claim 6, further comprising:
wheels mounted to a bottom of the base frame.

8. The fruit harvester as recited in claim 7, further comprising:
support struts extending between the base frame and the extendable frame.

9. The fruit harvester as recited in claim 8, further comprising:
handrails sized and positioned to be gripped and used to move the fruit harvester to a desired location.

10. The fruit harvester as recited in claim 1, further comprising a housing configured to store a power source.

11. The fruit harvester as recited in claim 10, further comprising a controller.

12. The fruit harvester as recited in claim 11, wherein the controller is configured to operate the winch.

13. The fruit harvester as recited in claim 11, wherein the controller is configured to operate the cutting tool.

14. The fruit harvester as recited in claim 11, wherein the controller is configured to operate the winch and the cutting tool.

15-16. (canceled)
